(19) United States
(12) Patent Application Publication
(10) Pub. No.: US 2011/0292290 A1
(43) Pub. Date: Dec. 1, 2011

(54) FREQUENCY CONVERSION CIRCUIT, FREQUENCY CONVERSION METHOD, AND ELECTRONIC APPARATUS

(75) Inventor: Tadashi Aizawa, Matsumoto-shi (JP)

(73) Assignee: SEIKO EPSON CORPORATION, Shinjuku-ku (JP)

(21) Appl. No.: 13/115,038

(22) Filed: May 24, 2011

(30) Foreign Application Priority Data
May 26, 2010 (JP) 2010-120177

(51) Int. Cl. H04N 5/21

(52) U.S. Cl. 348/607; 348/E05.077

(57) ABSTRACT

A frequency conversion circuit includes: a phase shifter that generates a first signal and a second signal having a phase difference of 90 degrees from the first signal; a first mixer that multiplies the first signal by a local oscillation signal; a second mixer that multiplies the second signal by the local oscillation signal; a first filter that extracts a signal component of an intermediate frequency from the output signal of the first mixer; a second filter that extracts a signal component of the intermediate frequency from the output signal of the second mixer; an image signal remover that removes an image signal from the output signals of the first and second filters; and a phase shift quantity adjuster that adjusts a phase shift quantity of the signal in the phase shifter based on the output signal of the image signal remover at a predetermined time.

This application claims priority to Japanese Patent Application No. 2010-120177, filed May 26, 2010, the entirety of which is hereby incorporated by reference.

### BACKGROUND

1. Technical Field

The present invention relates to a frequency conversion circuit, a frequency conversion method, and an electronic apparatus.

2. Related Art

In superheterodyne wireless communication devices, a frequency converting process of multiplying (combining) a received signal which is a high-frequency signal by a local oscillation signal (local signal) generated from a built-in oscillator by the use of a mixer and converting (converting down) the resultant signal into a signal of an intermediate frequency (IF signal) is carried out.

For example, a poly-phase filter is used to remove an image signal (a signal of a frequency with a symmetrical position of a desired signal to be received about the frequency of a local oscillation signal) generated by performing the frequency converting process. Specifically, a received signal is shifted in phase (the phase of a signal is changed) to generate two signals having phases different by 90 degrees, the generated two signals are multiplied by the local oscillation signal to convert the received signal into intermediate frequency signals which are orthogonal signals (I and Q signals) having a phase difference of 90 degrees, and the orthogonal signals are made to pass through the poly-phase filter to remove (cancel) the image signal.

In order to remove the image signal well, it is necessary to shift the phase of the received signal so as to accurately have a phase difference of 90 degrees. However, the phase difference may not accurately be 90 degrees due to the irregularity of circuit elements of a phase shifter circuit or the like in practice. Accordingly, in the phase shifter circuit disclosed in JP-T-2001-524770, a variable resistor of a phase shifter is controlled by a phase detector so that the phase difference between two output signals obtained by shifting the phase of an input high-frequency signal by ±45 degrees should be accurately 90 degrees.

However, in the phase shifter circuit disclosed in JP-T-2001-524770, the phase detector is made to always operate during the circuit operation to control the variable resistor of the phase shifter and thus there is a problem in that power consumption based on the phase detector is great.

When the frequency converting process to the IF signals is performed a local oscillation signal of a frequency apart from the frequency of the received signal by an intermediate frequency is generally used. However, the frequency of the local oscillation signal increases as the frequency of the received signal increases. As a result, the power consumption of the local oscillator increases. Accordingly, a method using a subharmonic mixer that acquires a signal of a differential frequency between the frequency of the received signal and the N-th harmonic of the local oscillation signal using a local oscillator with an oscillation frequency which 1/N of the necessary frequency of the local oscillation signal is known so as to reduce the power consumption of the local oscillator.

In a frequency conversion circuit using the subharmonic mixer, a Weber type circuit or a Hartley type circuit not using a phase shifter is used to reduce the power consumption and to satisfactorily remove the image signal. In this case, the orthogonal signals (I and Q signals) of the local oscillation signal is used, but since the orthogonal signals are generated by dividing the oscillation signal of the local oscillator, it is necessary to set the oscillation frequency of the local oscillator to double or higher the necessary frequency of the local oscillation signal, thereby enhancing the power consumption of the local oscillator.

### SUMMARY

An advantage of some aspects of the invention is that it provides a frequency conversion circuit that uses a subharmonic mixer and that can satisfactorily remove an image signal and reduce power consumption.

A first aspect of the invention is directed to a frequency conversion circuit including: a phase shifter that generates a first high-frequency signal and a second high-frequency signal having a phase difference of 90 degrees from the first high-frequency signal by shifting a phase of a high-frequency signal; a first mixer that multiplies the first high-frequency signal by a local oscillation signal; a second mixer that multiplies the second high-frequency signal by the local oscillation signal; a first filter that extracts a signal component of an intermediate frequency from an output signal of the first mixer; a second filter that extracts a signal component of the intermediate frequency from an output signal of the second mixer; an image signal remover that removes an image signal from an output signal of the first filter and an output signal of the second filter; and a phase shift quantity adjuster that adjusts a phase shift quantity of the high-frequency signal in the phase shifter based on an output signal of the image signal remover at a predetermined time.

Another aspect of the invention is directed to a frequency conversion method including: generating a first high-frequency signal and a second high-frequency signal having a phase difference of 90 degrees from the first high-frequency signal by shifting a phase of a high-frequency signal; multiplying the first high-frequency signal by a local oscillation signal to output a first multiplied signal; multiplying the second high-frequency signal by the local oscillation signal to output a second multiplied signal; extracting a first signal component of an intermediate frequency from the first multiplied signal; extracting a second signal component of the intermediate frequency from the second multiplied signal; removing an image signal from the first signal component and the second signal component to output an image-removed signal; and adjusting a phase shift quantity of the high-frequency signal at a time of generating the first high-frequency signal and the second high-frequency signal based on the image-removed signal.

According to the first aspect and the like of the invention, in the frequency conversion of shifting the phase of a high-frequency signal to generate the first high-frequency signal and the second high-frequency signal between which the phase difference is 90 degrees and multiplying the first high-frequency signal and the second high-frequency signal by the local oscillation signal to convert the first and second high-frequency signals into the signals of the intermediate frequency, the signals obtained by removing the image signal from the converted signal components of the intermediate frequency are fed back and thus the phase shift quantity of the high-frequency signal at the time of generating the first high-frequency signal and the second high-frequency signal is adjusted. Accordingly, it is possible to satisfactorily remove the image signal without being affected by the irregularity of the circuit elements of the phase shifter unit. Since the phase shift quantity is adjusted at a predetermined time such as a predetermined time interval, it is not necessary to always adjust the phase shift quantity during the operation of the frequency conversion circuit and it is thus possible to reduce power consumption.

A second aspect of the invention is directed to the frequency conversion circuit of the first aspect of the invention, wherein the first filter extracts as the signal component of the intermediate frequency a signal of a frequency, which is a difference between a frequency of the first high-frequency signal and a frequency of harmonics of the local oscillation signal, from the output signal of the first mixer, and the second filter extracts as the signal component of the intermediate frequency a signal of a frequency, which is a difference between a frequency of the second high-frequency signal and the frequency of the harmonics of the local oscillation signal, from the output signal of the second mixer.

According to the second aspect of the invention, the signal of a frequency which is a difference between the frequency of the high-frequency signal and the frequency of the harmonics of the local oscillation signal is extracted as the signal of the intermediate frequency from the signals obtained by multiplying the first high-frequency signal and the second high-frequency signal between which the phase difference is 90 degrees by the local oscillation signal. That is, it is possible to implement a frequency conversion circuit using a so-called subharmonic mixer and to lower the oscillation frequency of the local oscillator generating the local oscillation signal, thereby further reducing the power consumption.

A third aspect of the invention is directed to the frequency conversion circuit of the first or second aspect of the invention, wherein the phase shift quantity adjuster adjusts the phase shift quantity to a phase shift quantity by which a noise floor of the output signal of the image signal remover is the minimum while gradually changing the phase shift quantity in the phase shifter.

According to the third aspect of the invention, the phase shift quantity of the high-frequency signal is adjusted by setting the phase shift quantity by which the noise floor of the signal from which the image signal is removed is the minimum while gradually changing the phase shift quantity of the high-frequency signal.

A fourth aspect of the invention is directed to the frequency conversion circuit of the first or second aspect of the invention, which further includes: an image signal generator that generates the image signal; and a switch that switches a signal to be shifted in phase by the phase shifter to one of the high-frequency signal and the image signal, wherein when the switch switches the signal to be shifted to the image signal, the phase shifter generates a first image signal and a second image signal having a phase difference of 90 degrees from the first image signal by shifting a phase of the image signal generated by the image signal generator, the first mixer multiplies the first image signal by the local oscillation signal, the second mixer multiplies the second image signal by the local oscillation signal, and the phase shift quantity adjuster adjusts the phase shift quantity to a phase shift quantity by which a level of the output signal of the image signal remover is the minimum while gradually changing the phase shift quantity in the phase shifter.

According to the fourth aspect of the invention, the phase shift quantity of the high-frequency signal is adjusted by switching the high-frequency signal to the image signal generated in the circuit, shifting the phase of the image signal to generate the first image signal and the second image signal between which the phase difference is 90 degrees, and determining the phase shift quantity by which the level of the signal from which the image signal is removed is the minimum while gradually changing the phase shift quantity of the image signal. That is, it is possible to determine the phase shift quantity when the image signal is maximally removed.

A fifth aspect of the invention is directed to the frequency conversion circuit of any of the first to fourth aspects of the invention, wherein the phase shifter includes an RC filter including a resistor and a capacitor, and the phase shift quantity adjuster adjusts the phase shift quantity by changing at least one of a value of the resistor and a value of the capacitor.

A sixth aspect of the invention is directed to the frequency conversion circuit of any of the first to fifth aspects of the invention, wherein the high-frequency signal is a satellite signal transmitted from a positioning satellite.

A seventh aspect of the invention is directed to an electronic apparatus having the frequency conversion circuit of any of the first to sixth aspects of the invention.

### BRIEF DESCRIPTION OF THE DRAWINGS

The invention will be described with reference to the accompanying drawings, wherein like numbers reference like elements.

FIG. 1 is a diagram illustrating the configuration of a GPS receiver device.

FIG. 2 is a diagram illustrating the configuration of a frequency conversion unit.

FIG. 3 is a diagram illustrating a data structure of a time table.

FIG. 4 is a flow diagram illustrating the flow of a process performed by a baseband unit.

FIG. 5 is a diagram illustrating another configuration of the frequency conversion unit.

### DESCRIPTION OF EXEMPLARY EMBODIMENTS

Hereinafter, an exemplary embodiment of the invention will be described with reference to the accompanying drawings. It is assumed in the following description that the invention is applied to a GPS receiver device receiving a GPS satellite signal transmitted from a GPS (Global Positioning System) satellite which is a kind of positioning satellite, but the invention is not limited to this embodiment.

### Configuration

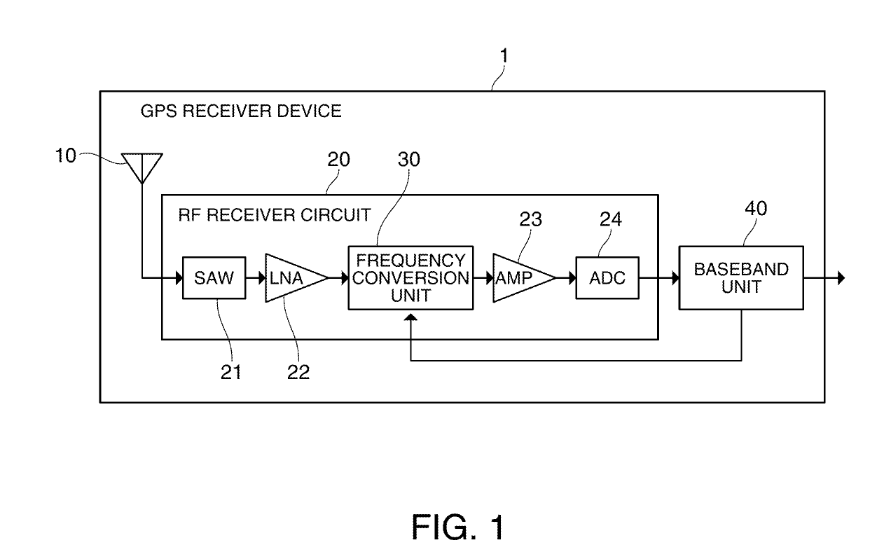

FIG. 1 is a block diagram illustrating the configuration of a GPS receiver device 1 according to the exemplary embodiment. As shown in FIG. 1, the GPS receiver device 1 includes a GPS antenna 10, an RF (Radio Frequency) receiver circuit 20, and a baseband unit 40 (phase shift quantity adjusting unit).

The GPS antenna 10 receives an RF signal including a GPS satellite signal transmitted from a GPS satellite which is a kind of positioning satellite. The GPS satellite signal is a communication signal of 1.57542 [GHz] modulated by a direct spectrum spread method with a PRN (Pseudo Random Noise) code which is a kind of spread code varying depending on GPS satellites. The PRN code is a pseudo random noise code with a repetition period 1 [ms] and with a code length of 1023 chips as a frame.

The RF receiver circuit 20 includes an SAW (Surface Acoustic Wave) filter 21, an LNA (Low Noise Amplifier) 22, a frequency conversion unit 30, an amplifier unit 23, and an ADC (Analog-to-Digital Converter) 24.

The SAW filter 21 is a band-pass filter which passes a frequency component of a predetermined band of the RF signal (a received signal or a high-frequency signal) received by the GPS antenna 10, and blocks frequency components outside the band. The LNA 22 is a low noise amplifier and amplifies the RF signal output from the SAW filter 21.

The frequency conversion unit 30 performs a frequency conversion process of a subharmonic type of synthesizing the RF signal output from the LNA 22 with a local oscillation signal Lo of a frequency F_{Lo} which is approximately 1/N of the frequency F_{RF} so as to convert the RF signal into an intermediate frequency signal (IF signal) of a frequency |F_{RF}−F_{Lo}×N|. Here, “N” is an integer equal to or greater than 1. The frequency conversion unit 30 and the baseband unit 40 constitute a “frequency conversion circuit”.

The amplifier unit 23 amplifies the IF signal output from the frequency conversion unit 30. The ADC 24 converts the IF signal which is an analog signal output from the amplifier unit 23 into a digital signal.

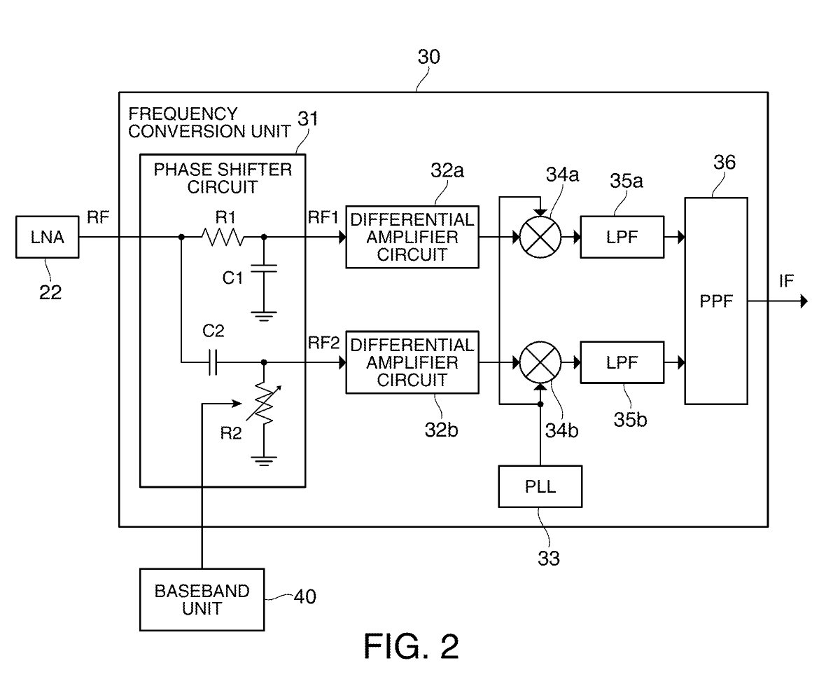

FIG. 2 is a block diagram illustrating the configuration of the frequency conversion unit 30. As shown in FIG. 2, the frequency conversion unit 30 includes a phase shifter circuit 31 (phase shifter unit), differential amplifier circuits 32a and 32b, a PLL (Phase Locked Loop) 33, mixers 34a and 34b (the first mixer unit and the second mixer unit), LPFs (Low-Pass Filters) 35a and 35b (the first filter unit and the second filter unit), and a PPF (Poly-Phase Filter) 36 (the image signal removing circuit).

The phase shifter circuit 31 converts the phase of an input RF signal and generates a pair of phase-difference received signals (orthogonal signals) RF1 and RF2 (the first high-frequency signal and the second high-frequency signal) between which the phase difference is 90 degrees. The phase shifter circuit 31 is made up of an RC filter (an HPF (High-Pass Filter) and an LPF). That is, the LPF including a resistor R1 and a capacitor C1 generates a signal RF1 obtained by delaying the phase of the input RF signal by 45 degrees and the HPF including a resistor R2 and a capacitor C2 generates a signal RF2 obtained by advancing the phase of the input RF signal by 45 degrees. Here, the resistor R2 is a variable resistor and the resistance value thereof is variably controlled by the baseband unit 40.

The differential amplifier circuits 32a and 32b convert the signals RF1 and RF2 output from the phase shifter circuit 31 into differential signals. That is, the differential amplifier circuit 32a generates differential signals (an original signal RF1₊ and an inverted signal RF1₋) of the signal RF1 and the differential amplifier circuit 32b generates differential signals (an original signal RF2₊ and an inverted signal RF2₋) of the signal RF2.

The PLL 33 generates a local oscillation signal Lo of a frequency F_{Lo} which is approximately 1/N of the frequency F_{RF} of the received RF signal. More specifically, the PLL 33 generates a local oscillation signal Lo of a frequency F_{Lo} satisfying |F_{RF}−F_{Lo}×N|=intermediate frequency F_{IF}. In the GPS receiver device 1, only a wave which is a GPS satellite signal is received and thus only a wave may be generated by the PLL 33. Accordingly, it is possible to generate a high-precision frequency with small power consumption.

The mixers 34a and 34b multiply (synthesize) the signals output from the differential amplifier circuits 32a and 32b by the local oscillation signal Lo generated by the PLL 33. The mixers 34a and 34b are made up of, for example, a Gilbert cell mixer. That is, the mixer 34a generates a signal (I signal) obtained by multiplying (synthesizing) the differential signals (the original signal RF1₊ and the inverted signal RF1₋) of the signal RF1 output from the differential amplifier circuit 32a by the local oscillation signal Lo. The mixer 34b generates a signal (Q signal) obtained by multiplying (synthesizing) the differential signals (the original signal RF2₊ and the inverted signal RF2₋) of the signal RF2 output from the differential amplifier circuit 32b by the local oscillation signal Lo.

The mixers 34a and 34b are used as a subharmonic mixer, and thus the signals (I and Q signals) output from the mixers 34a and 34b include a signal of a frequency |F_{RF}−F_{Lo}×N| which is a frequency difference between the RF signal and the N-th harmonics of the local oscillation signal Lo.

The LPFs 35a and 35b pass a signal of a low band including the frequency |F_{RF}−F_{Lo}×N| component which is the frequency difference between the RF signal and the N-th harmonics of the local oscillation signal Lo among the signals output from the mixers 34a and 34b and block the frequency component outside the band. A desired IF signal is extracted from the output signals of the mixers 34a and 34b by the LPFs 35a and 35b. That is, an in-phase component signal (I signal) of the IF signal is extracted by the LPF 35a and an orthogonal component signal (Q signal) of the IF signal is extracted by the LPF 35b.

The PPF 36 removes an image signal from the IF signals output from the LPFs 35a and 35b. The PPF 36 is a four-phase RC filter and four signals having phases different by 90 degrees are input thereto. That is, differential signals I₊ and I₋ of the I signal are input from the LPF 35a and differential signals Q₊ and Q₋ of the Q signal are input from the LPF 35b.

Referring to FIG. 1 again, the baseband unit 40 performs a correlation process on the IF signals output from the RF receiver circuit 20, captures a GPS satellite signal, decodes data to extract a navigation message or time information, and performs a pseudo distance calculating process or a position calculating process.

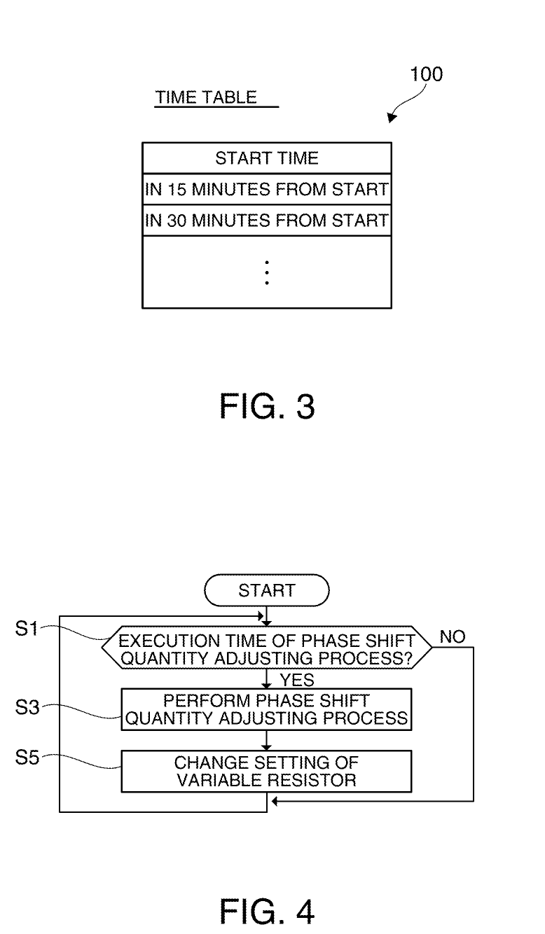

The baseband unit 40 performs a phase shift quantity adjusting process of controlling the variable resistor R2 of the phase shifter circuit 31 on the basis of the IF signals (digital signals) output from the RF receiver circuit 20, so that the effect of removing the image signal in the RF receiver circuit 20 is the maximum. Specifically, when the execution time determined by a time table 100 of which an example is shown in FIG. 3 is reached, the resistance value of the variable resistor R2 is gradually changed within a predetermined range centered on the present resistance value and the noise floor (the lowest level of a noise) of the IF signals (digital signals) output from the RF receiver circuit 20 is measured while changing the resistance value of the variable resistor R2. Since the GPS receiver device 1 receives only a wave which is the GPS satellite signal of which the frequency is determined, the frequencies of the noise floors of the IF signals are determined in advance. By detecting a signal strength at the frequency of the noise floor, the noise floor of the IF signal is measured. The variable resistor R2 is changed and set to the resistance value of the variable resistor R2 when the measured noise floor is the lowest.

FIG. 4 is a flow diagram illustrating the flow of processes in the baseband unit 40. FIG. 4 shows only processes associated with the adjustment of the phase shift quantity in the phase shifter circuit 31 which is the most important feature of this embodiment.

As shown in FIG. 4, it is first determined whether the execution time determined by the time table 100 is reached. When it is determined that the execution time is not reached (NO in step S1), the execution time is waited for. When it is determined the execution time is reached (YES in step S1), the phase shift quantity adjusting process is performed (step S3). In the phase shift quantity adjusting process, the resistance value of the variable resistor R2 in the phase shifter circuit 31 is changed within a predetermined range centered on the present resistance value, the noise floor of the IF signal output from the RF receiver circuit 20 is measured, and the resistance value at which the measured noise floor is the minimum is determined. Thereafter, the resistance value of the variable resistor R2 is reset to the resistance value which is determined as the optimum for the phase shift quantity adjusting process (step S5). Thereafter, the same processes are repeated from step S1.

### Operations and Advantages

In this way, in the GPS receiver device 1 according to this embodiment, the phase shift quantity in the phase shifter circuit 31 is adjusted at a predetermined time. Specifically, the resistance value of the variable resistor R2 of the phase shifter circuit 31 is gradually changed, for example, in a predetermined range centered on the present resistance value and the resistance value of the variable resistor R2 is determined by which the noise floor of the IF signal output from the RF receiver circuit 20 is the minimum. The variable resistor R2 is changed and set to the determined resistance value. Accordingly, it is possible to satisfactorily remove the image signal and the oscillation frequency of the PLL 33 has only to be set to the frequency of the local oscillation signal Lo, thereby effectively reducing the power consumption.

### Modified Example

An applicable embodiment of the invention is not limited to the above-mentioned embodiment, but may be modified in various forms without departing from the concept of the invention.

### (A) Variable Resistor R2

Although it has been described in the above-mentioned embodiment that a variable resistor is used as the variable resistor R2 of the phase shifter circuit 31 and the resistance value thereof is changed, a variable resistor may be used as the resistor R1 or a variable capacitor may be used as one of the capacitors C1 and C2.

Although it has been described in the above-mentioned embodiment that a variable resistor is used as the resistor R2 and the resistance value thereof is variable, plural resistors may be connected in parallel to constitute a resistor unit which becomes the resistor R2 as a whole and the total resistance value may be changed by switching the connected resistors. A resistor unit or a capacitor unit may be similarly constituted for the resistor R1 or the capacitors C1 and C2.

### (B) Adjustment of Phase Shift Quantity

A signal (image signal) of an image frequency to be removed in the RF receiver circuit 20 may be generated and the resistance value of the resistor R2 by which the signal level of the output signal is the minimum when the image signal is input to the RF receiver circuit 20 instead of the received signal may be determined.

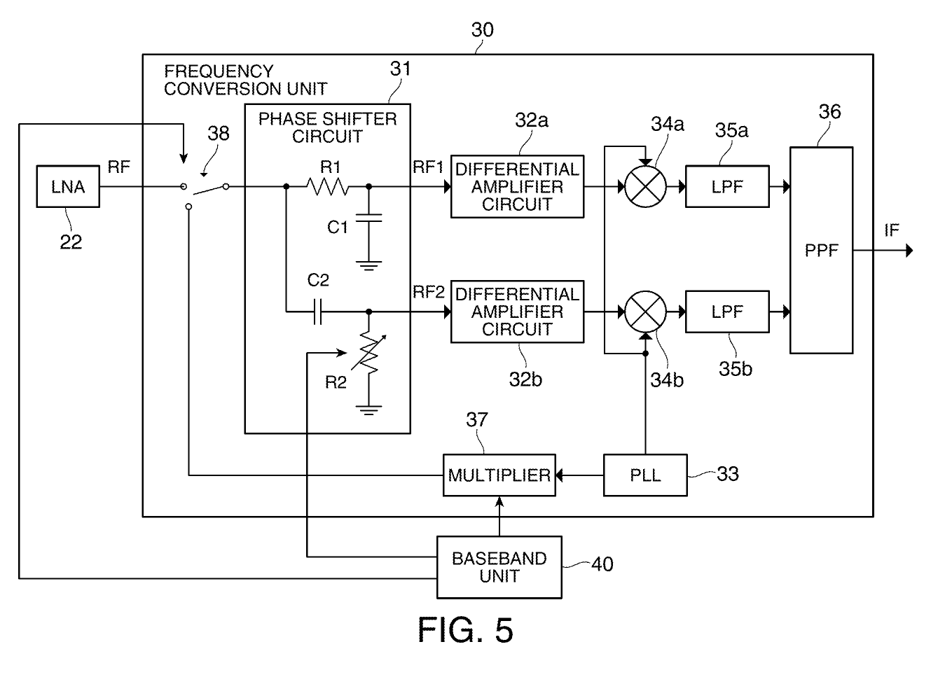

Specifically, as shown in FIG. 5, the frequency conversion unit 30 is configured to include a multiplier 37 (the image signal generating unit) and a switch unit 38 (the signal switching unit). In FIG. 5, the same elements as the frequency conversion circuit 30 (see FIG. 2) are referenced by the same reference numerals and signs and the detailed description thereof is not repeated.

The multiplier 37 multiplies/divides the local oscillation signal Lo generated from the PLL 33 and generates a signal (image signal) of an image frequency to be removed.

The switch unit 38 is an SPDT (Single Pole Double Throw) switch, the input side thereof is switched and connected to the output terminal of the LNA 22 or the output terminal of the multiplier 37, and the output side thereof is connected to the input terminal of the phase shifter circuit 31. The switching of the switch unit 38 is controlled by the baseband unit 40. That is, the input side is connected to the LNA 22 when the phase shift quantity is not adjusted (in the normal operation), and is connected to the multiplier 37 when the phase shift quantity is adjusted.

The baseband unit 40 switches the input of the switch unit 38 to the multiplier 37 at the time of performing the phase shift quantity adjusting process. Then, the resistance value of the variable resistor R2 by which the signal level of the output signal of the frequency conversion unit 30 is the minimum is determined while gradually changing the resistance value of the variable resistor R2 of the phase shifter circuit 31. The variable resistor R2 is changed and set to the determined resistance value. Thereafter, the input of the switch unit 38 is switched to the GPS antenna 10.

Similarly in this case, a variable resistor may be used as the resistor R1 instead of the resistor R2 or a variable capacitor may be used as one of the capacitors C1 and C2. The resistors R1 and R2 may be configured as a resistor unit in which plural resistors are connected in parallel, or the capacitors C1 and C2 may be configured as a capacitor unit in which plural capacitors are connected in series.

### (C) Execution Time of Phase Shift Quantity Adjusting Process

Although it has been described in the above-mentioned embodiment that the execution time of the phase shift quantity adjusting process determined by the time table 100 (see FIG. 3) includes “the start time of the GPS receiver device 1 and intervals of 15 minutes from the start time”, the execution time may include only the “start time”. The execution time interval is not limited to the intervals of 15 minutes, but may be intervals of several minutes. Alternatively, the execution time interval may not be constant, like “the start time, in 30 minutes from the start time, and in 45 minutes from the start time”.

### (D) Application

The invention can be applied to various electronic apparatuses such as a personal computer in addition to the GPS receiver device.

What is claimed is:

1. A frequency conversion circuit comprising:
a phase shifter that generates a first high-frequency signal and a second high-frequency signal having a phase difference of 90 degrees from the first high-frequency signal by shifting a phase of a high-frequency signal;
a first mixer that multiplies the first high-frequency signal by a local oscillation signal;
a second mixer that multiplies the second high-frequency signal by the local oscillation signal;
a first filter that extracts a signal component of an intermediate frequency from an output signal of the first mixer;
a second filter that extracts a signal component of the intermediate frequency from an output signal of the second mixer;
an image signal remover that removes an image signal from an output signal of the first filter and an output signal of the second filter; and
a phase shift quantity adjuster that adjusts a phase shift quantity of the high-frequency signal in the phase shifter based on an output signal of the image signal remover at a predetermined time.

2. The frequency conversion circuit according to claim 1, wherein the first filter extracts as the signal component of the intermediate frequency a signal of a frequency, which is a difference between a frequency of the first high-frequency signal and a frequency of harmonics of the local oscillation signal, from the output signal of the first mixer, and
the second filter extracts as the signal component of the intermediate frequency a signal of a frequency, which is a difference between a frequency of the second high-frequency signal and the frequency of the harmonics of the local oscillation signal, from the output signal of the second mixer.

3. The frequency conversion circuit according to claim 1, wherein the phase shift quantity adjuster adjusts the phase shift quantity to a phase shift quantity by which a noise floor of the output signal of the image signal remover is the minimum while gradually changing the phase shift quantity in the phase shifter.

4. The frequency conversion circuit according to claim 1, further comprising:
an image signal generator that generates the image signal; and
a switch that switches a signal to be shifted in phase by the phase shifter to one of the high-frequency signal and the image signal,
wherein when the switch switches the signal to be shifted to the image signal,
the phase shifter generates a first image signal and a second image signal having a phase difference of 90 degrees from the first image signal by shifting a phase of the image signal generated by the image signal generator,
the first mixer multiplies the first image signal by the local oscillation signal,
the second mixer multiplies the second image signal by the local oscillation signal, and
the phase shift quantity adjuster adjusts the phase shift quantity to a phase shift quantity by which a level of the output signal of the image signal remover is the minimum while gradually changing the phase shift quantity in the phase shifter.

5. The frequency conversion circuit according to claim 1, wherein the phase shifter includes an RC filter including a resistor and a capacitor, and
the phase shift quantity adjuster adjusts the phase shift quantity by changing at least one of a value of the resistor and a value of the capacitor.

6. The frequency conversion circuit according to claim 1, wherein the high-frequency signal is a satellite signal transmitted from a positioning satellite.

7. A frequency conversion method comprising:
generating a first high-frequency signal and a second high-frequency signal having a phase difference of 90 degrees from the first high-frequency signal by shifting a phase of a high-frequency signal;
multiplying the first high-frequency signal by a local oscillation signal to output a first multiplied signal;
multiplying the second high-frequency signal by the local oscillation signal to output a second multiplied signal;
extracting a first signal component of an intermediate frequency from the first multiplied signal;
extracting a second signal component of the intermediate frequency from the second multiplied signal;
removing an image signal from the first signal component and the second signal component to output an image-removed signal; and
adjusting a phase shift quantity of the high-frequency signal at a time of generating the first high-frequency signal and the second high-frequency signal based on the image-removed signal.

8. An electronic apparatus comprising the frequency conversion circuit according to claim 1.
